(19) United States
(12) Patent Application Publication
(10) Pub. No.: US 2007/0294145 A1
(43) Pub. Date: Dec. 20, 2007

(54) Method for Conducting a Drywall Business

(76) Inventor: David R. Hall, Provo, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 11/306,302

(22) Filed: Dec. 22, 2005

(51) Int. Cl. G06Q 10/00

(52) U.S. Cl. 705/28; 705/1

(57) ABSTRACT

A method for conducting a drywall equipment business comprises the following steps: providing a motor vehicle suitable to be stocked with drywall equipment, staffing the motor vehicle by a first party, the first party providing drywall equipment to a second party from the motor vehicle, and the first party charging the second party for providing at least some of the drywall equipment.

### BACKGROUND OF THE INVENTION

This invention pertains to a method for conducting a drywall equipment business. In the drywall industry, the ability to provide superior service at the lowest possible cost may be imperative. Unproductive time dealing with tool maintenance and/or returning tools to a renter may frustrate consumers. In the prior art, companies provide drywall tools to consumers at their stores. An example of the drywall tools provided by Ames Tools is disclosed in U.S. Pat. No. 4,086,121. Another drywall tool provided by another company is disclosed in U.S. Patent Publication Number U.S. 2004/0244916.

Other companies, such as RSC Equipment Rental (rscrental.com) and Hertz Equipment Rental (hertzequip.com), provide construction tools for use on a large scale. RSC Equipment Rental's website states that they provide special on-site tool trailers for shutdowns, turnarounds, and new construction environments, which may be left at a jobsite. Hertz Equipment Rental's website states that they have full-size trailers available for temporary or continuous on-location service. In another industry Snap-on, Inc (snapon.com) and Mac Tools (mactools.com) use motor vehicles to sell automotive products to their consumers.

### BRIEF SUMMARY OF THE INVENTION

In one aspect of the invention, a method for conducting a drywall business comprises the following steps: providing a motor vehicle suitable to be stocked with drywall equipment; staffing the motor vehicle by a first party; the first party providing drywall equipment to a second party, who may be an end user or an agent of the end user, from the motor vehicle; and the first party charging the second party for providing at least some of the drywall equipment.

The motor vehicle, which may be an automobile, automobile with a trailer, trucks, trucks with semi trailers, airplanes, trains, and boats, may have systems for tracking equipment inventory and for charging the second party. The motor vehicle may also have a plurality of racks and/or shelves for storing drywall equipment and may have areas for providing services pertaining to the drywall equipment, such services may include: repairs, upgrades, exchanges, and/or cleaning drywall equipment. The motor vehicle may be staffed with a first party who may be an agent of the business. The motor vehicle allows the first party to come to the second party to rent, lease, service, and/or sell drywall equipment, which may save the second party time and money. The first party may also charge the second party, proximate the motor vehicle, for at least some of the drywall equipment. Such a vehicle may be capable of saving the second party time and money.

### BRIEF DESCRIPTION OF THE DRAWINGS

The foregoing and other features of the present invention will become more fully apparent from the following description, taken in conjunction with the accompanying drawings. Understanding that these drawings depict only typical embodiments in accordance with the invention and are, therefore, not to be considered limiting of its scope, the invention will be described with additional specificity and detail through use of the accompanying drawings in which:

FIG. 1 is a schematic of an embodiment of a method for conducting a drywall business.

FIG. 2 is a schematic of another embodiment of a method for conducting a drywall business.

FIG. 3 is a perspective diagram of an embodiment of providing drywall equipment proximate the vehicle.

FIG. 4 is a perspective diagram of an embodiment of an interior of a motor vehicle.

FIG. 5 is a perspective diagram of an embodiment of systems for tracking inventory and charging the second party.

FIG. 5a is a perspective diagram of an embodiment of a wireless system for tracking inventory and/or related to payment.

FIG. 6 is a perspective diagram of an embodiment of a motor vehicle.

FIG. 7 is a perspective diagram of another embodiment of a motor vehicle.

FIG. 8 is a perspective diagram of an embodiment of a tool that may be stocked in the motor vehicle.

FIG. 9 is a schematic of an embodiment of drywall equipment that may be stocked in the motor vehicle.

### DETAILED DESCRIPTION OF THE INVENTION AND THE PREFERRED EMBODIMENT

It will be readily understood that the components of the present invention, as generally described and illustrated in the Figures herein, could be arranged and designed in a wide variety of different configurations. Thus, the following more detailed description of embodiments of apparatus and methods of the present invention, as represented in the Figures is not intended to limit the scope of the invention, as claimed, but is merely representative of various selected embodiments of the invention.

The illustrated embodiments of the invention will best be understood by reference to the drawings, wherein like parts are designated by like numerals throughout. Those of ordinary skill in the art will, of course, appreciate that various modifications to the apparatus and methods described herein may easily be made without departing from the essential characteristics of the invention, as described in connection with the Figures. Thus, the following description of the Figures is intended only by way of example, and simply illustrates certain selected embodiments consistent with the invention as claimed herein.

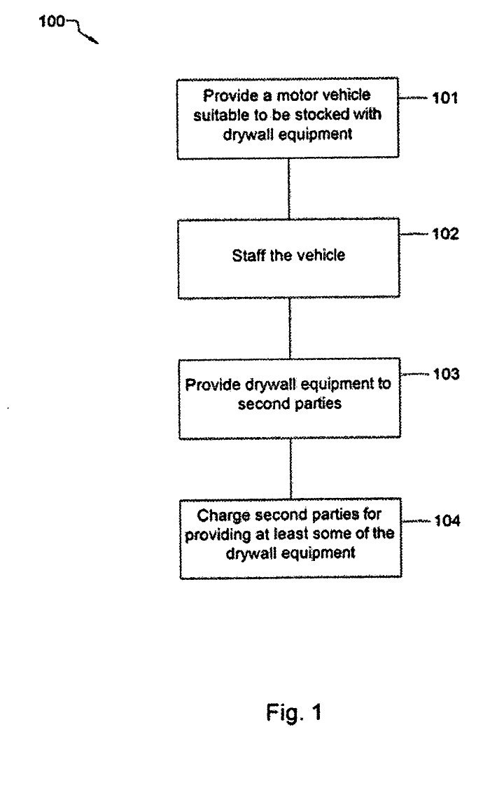

FIG. 1 is a schematic of an embodiment of a method for conducting a drywall business. One step of the method 100 includes, providing 101 a motor vehicle suitable to be stocked with drywall equipment. This vehicle is staffed 102 by the first party. The first party may be at least one person who is an employee and/or an agent of the business. The first party provides 103 drywall equipment to at least one second party, which may be end users or agents of end users. The second party may comprise a contractual employee, part-time employee, full-time employee, seasonal employee, volunteer, do-it-yourselfer, or combinations thereof. The first party also charges 104, proximate the vehicle, the second party for providing at least some of the drywall equipment.

Further, the step of providing drywall equipment 103 may comprise renting, leasing, selling, or combinations thereof. Renting may secure the use of the drywall equipment for a short period of time and charges maybe assessed according to the rental agreement. Leasing may last for a longer period than renting and charges may be assessed according to the lease agreement. Unlike renting or leasing, the drywall equipment may be sold and may include service options for the second party.

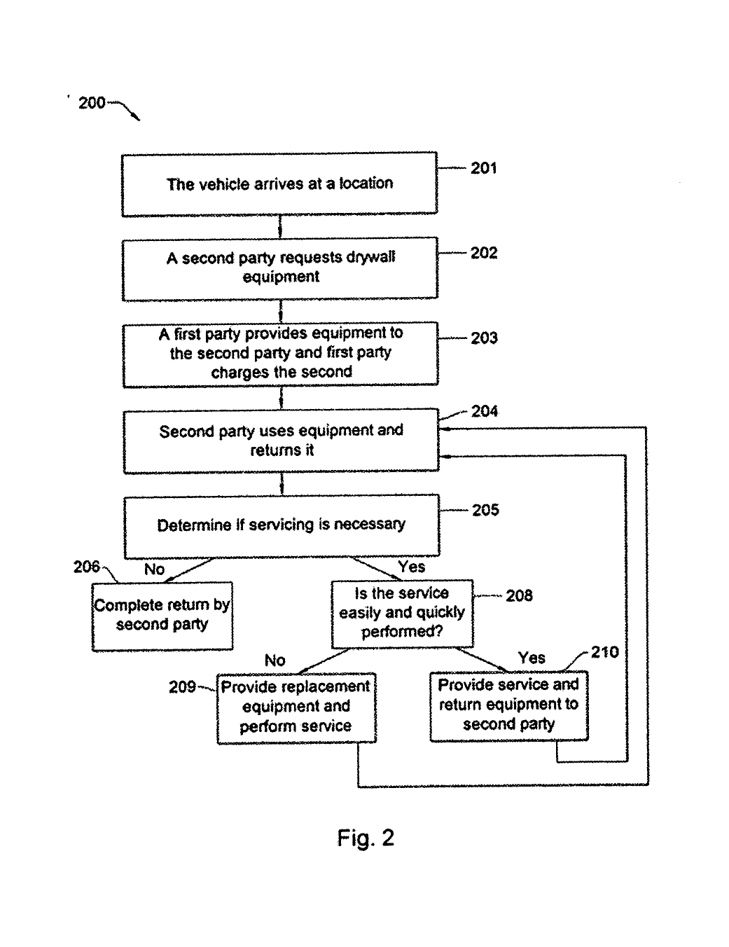

FIG. 2 is a schematic of another embodiment of a method 200 for conducting a drywall business. The motor vehicle arrives 201 at a location that may be proximate a jobsite. A second party requests 202 drywall equipment. A first party provides 203 the equipment to the second party and the first party may charge the second party. The second party uses 204 the equipment and return it to the motor vehicle. The second party may return to the vehicle when it is finished using the equipment, needs a replacement, needs a service performed, desires additional drywall equipment, or combinations thereof. If the second party is finished with the drywall equipment, the first party completes 206 the return. If it is determined 205 that servicing is needed and it is determined 208 that the problem is not easily fixed, the first party may provide replacement equipment 209 and allow the second party to continue working while the first party services the equipment 209. The first party may determine 208 that the problem is easily fixed and service 210 the equipment proximate the vehicle. More complicated maintenance may take place at a remote location. In some situations the broken equipment may be repaired quickly enough so that the second party may continue to use the same drywall equipment 210.

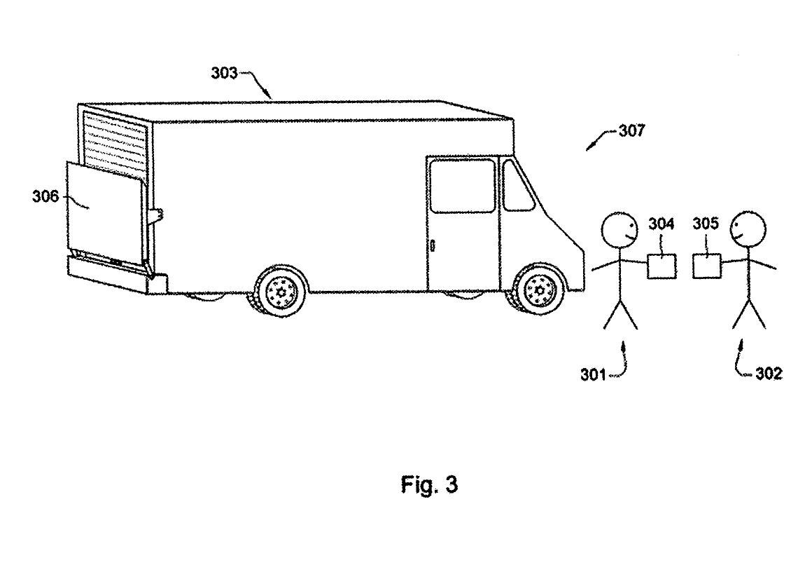

FIG. 3 is a perspective diagram of an embodiment of providing drywall equipment proximate a motor vehicle 303. The first party 301 may provide the second party 302 with drywall equipment 304 proximate the vehicle 303. The second party 302 may use a method of payment 305. The method of payment 305 may comprise cash, check, cashier's check, money order, debit card, credit card, collateral, or combinations thereof. Still referring to FIG. 3, in some embodiments the second party 302 may return used drywall equipment 304 to the first party 301. The first party 301 may provide the second party 302 with replacement drywall equipment and then service the returned drywall equipment proximate the vehicle 303. Service performed proximate the vehicle may be performed inside or outside the vehicle 303. For example, the vehicle's platform 306 may be dropped down and used as a table for performing the services required. The vehicle's platform 306 may also be used as a receiving area for returned drywall equipment while the front of the vehicle 307 may be used for distributing the drywall equipment to the second party 302 or vice versa.

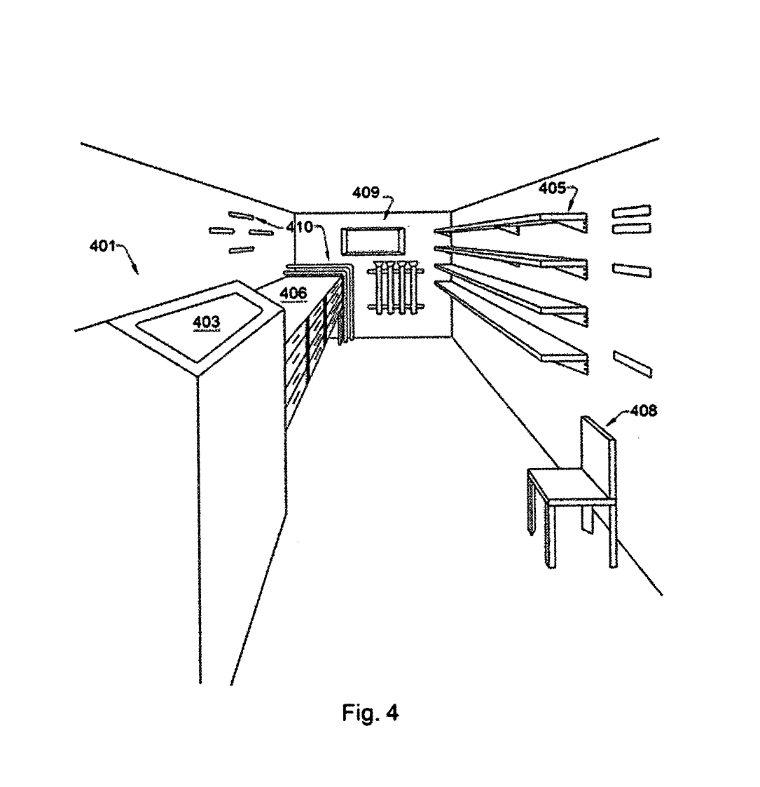

FIG. 4 is a perspective diagram of an embodiment of an interior of a motor vehicle. The motor vehicle 303 may comprise an area 401 to perform the services pertaining to the drywall equipment. The services pertaining to the drywall equipment may comprise repairing, cleaning, replacing, replenishing, upgrading, or combinations thereof. The area 401 may comprise a recirculating washer 403. A recirculating washer is a washer which circulates a cleaning liquid between a reservoir and a washing area. The recirculating washer 403 may comprise an enclosed washing area. A benefit of a recirculating washer 403 is that a relatively small reservoir may be used and carried by the motor vehicle. A filter may be used to preserve the recirculating liquid. The reservoir may also be constructed to allow particulate matter to settle on an internal bottom surface of the reservoir and have clean liquid drawn from the top of the reservoir. Equipment may be placed inside the enclosed power washer and the first party may handle the equipment inside the enclosed area by using gloves attached to the wall of the recirculating washer 403. The gloves may be adapted to allow the first party to insert his or her hands into the gloves and handle the equipment enclosed in the washer without exposing the first party's hands within the enclosure. When turned on, the equipment may be exposed to an abrasive material, such as sand, water, or combinations thereof, which may allow the first party to clean the equipment more easily. In other embodiments, the vehicle may comprise a high pressure hose for cleaning the equipment inside or outside of the vehicle. The recirculating washer 403 may include a means of manual cleaning e.g. a basin secured to the vehicle in which drywall equipment may be washed by hand. The recirculating washer 403 may be connected to an electrical system located on the motor vehicle 303. Additionally, a generator secured to the vehicle may be a part of the vehicle's electrical system. The motor vehicle may also comprise a servicing area 401 to perform other services pertaining to drywall equipment. The servicing area 401 may include a shelf 405, a table 406, a chair 408, a ledge 409, or combinations thereof. The motor vehicle 303 may contain a plurality of racks 410 and/or a plurality of shelves 405 for stocking drywall equipment.

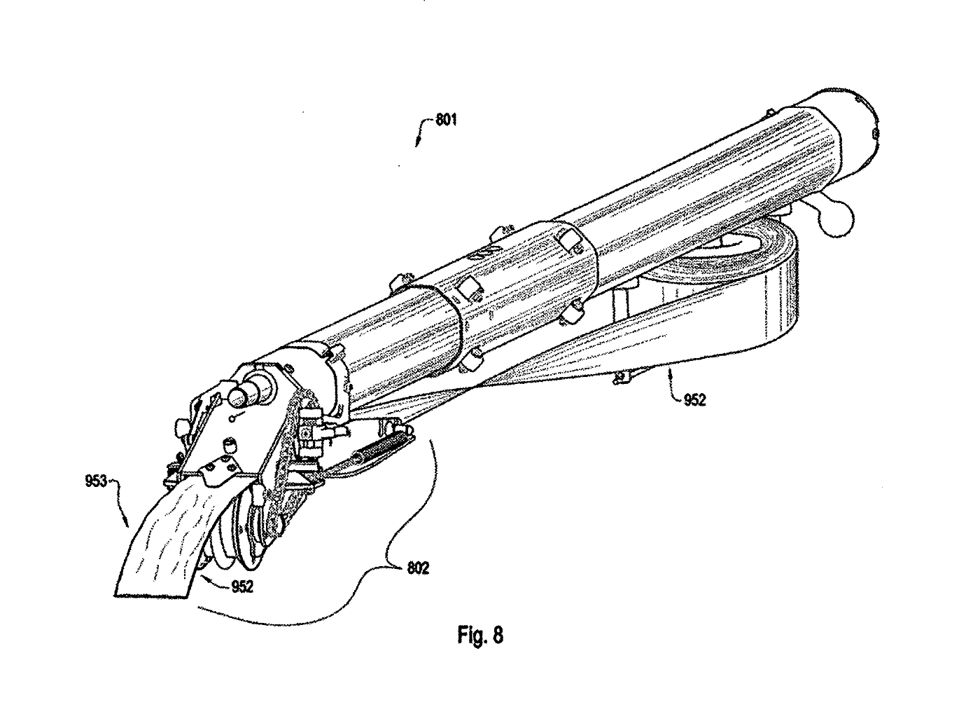

The services pertaining to the drywall equipment may vary. Replacing equipment may also be an important service when equipment becomes damaged or is in need of cleaning. Onsite cleaning and/or repair may save time and money, especially if the damaged or dirty equipment is readily replaceable, allowing the second party to continue working. Replenishing materials, such as joint compound and joint tape, may also be important. On-hand materials in the motor vehicle 303, may allow replenishing to be done quickly. Upgrades may also be performed proximate the motor vehicle 303. If new drywall equipment is released, the first party may circulate older equipment out and replace it with the newer equipment. Further services will be described in relation to FIG. 8.

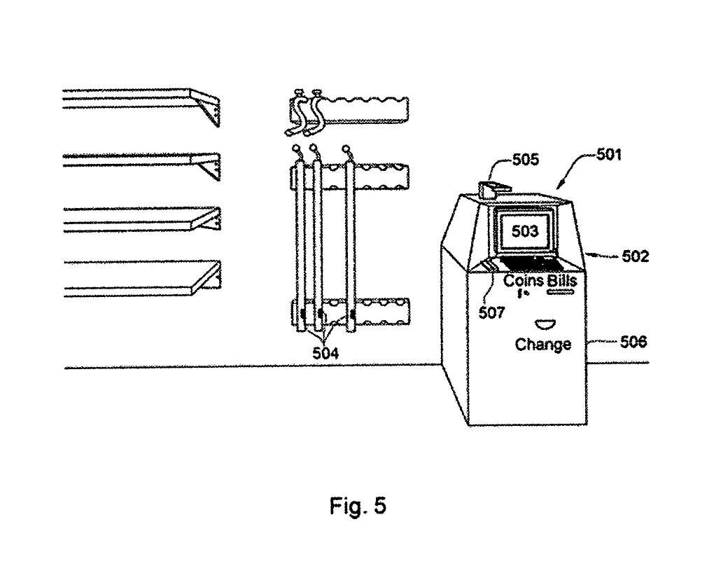

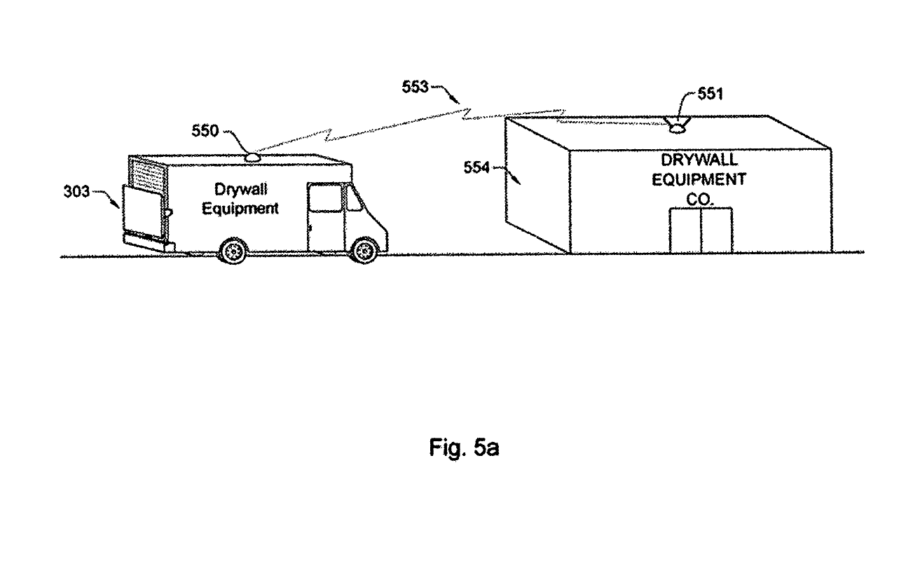

FIG. 5 is a perspective diagram of an embodiment of a system 501 for tracking inventory. Also shown in the FIG. 5 is a system 502 related to payment for charging the customer. The functions performed by the system 502 may comprise creating a bill, initiating payment, processing payment, completing payment, confirming payment, or combinations thereof. The system 501 for tracking inventory may be manual (paper and writing implement), mechanical (mechanical cash register), electronic (computer 503, RFID, video verification), optical (barcode 504 and barcode scanner 505), or combinations thereof. The system 502 related to payment may be manual (ledger), mechanical (mechanical cash register), electronic (computer 503, apparatus for swiping a credit card 507), or combinations thereof. Additionally, the system 502 related to payment may have a cash machine 506 to enable the second party 302 to pay with cash while providing security for the money. The cash machine 506 may be connected to the computer 503. A cash box may also be used for the handling of cash transactions. The system 502 may also have a secure box or safe for checks to enable the second party 302 to pay with a check. The system 502 for charging may include a credit/debit card reader 507. When a credit card is swiped, the computer 503 records the card's information. The inventory system 501 may include providing the drywall equipment with a magnetic strips or bar codes which may be recorder by a scanner 505. Further, the computer 503 and wireless system described hereafter in FIG. 5a may enable the first party to accept electronic checks.

FIG. 5a is a perspective diagram of an embodiment of a wireless system for tracking inventory and/or related to payment. It further demonstrates the utility of the system for tracking inventory and the system related to payment. The system for tracking inventory and the system related to payment may be connected to a remote location 554 via a wireless connection. The wireless signal 553 may be sent from the vehicle 303 via a first wireless transceiver 550 using protocols such as WiFi, Bluetooth; means such as radio, cellular, infrared; apparatuses such as satellite dishes, cards for computers or PDAs that connect through cell phone service providers; or combinations thereof. The wireless signal 553 may be received by second wireless transceiver 551, at a remote location 554 and may be connected to a remote server. It may enable real-time updates to customer accounts rather than waiting for the updates to be done at specific intervals.

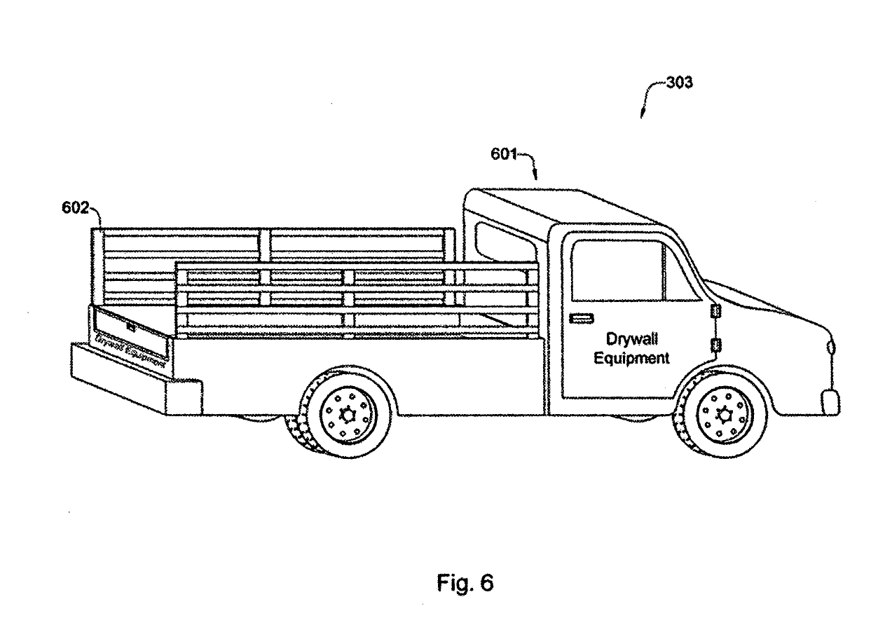

FIG. 6 is a perspective diagram of an embodiment of a motor vehicle. The vehicle 303 may be a truck pick-up truck 601. The pick-up truck 601 may have racks 602, a camper/utility shell, or an apparatus for the division, organization, dispensing, or storage of drywall equipment. For example, a pick-up truck 601 may have dividers in the cargo bed or a unit with shelves and drawers for storing equipment. A pick-up truck 601 may be useful for jobs that require providing drywall equipment at various locations, transporting drywall equipment, and providing basic services.

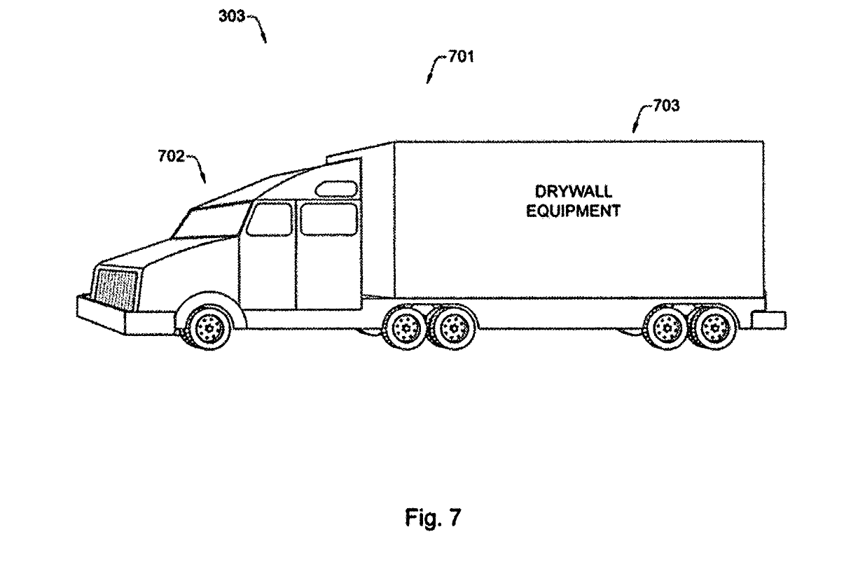

FIG. 7 is a perspective diagram of an embodiment of a motor vehicle. The vehicle 303 may be a tractor-trailer 701 comprising at least a tractor 702 and a semi-trailer 703. The semi-trailer 703 and/or the tractor 702 may be stocked with drywall equipment, have at least some of the areas described in FIG. 4, have at least one of the systems described in FIG. 5, or combinations thereof. Such an embodiment may be useful for large scale projects such as a building or repairing commercial or residential building or developments.

FIG. 8 is a perspective diagram of an embodiment of a tool that may be stocked in the motor vehicle. Such a tool 801 may be known as an automatic taper. The automatic taper 801 may be filled with joint compound 953 and may have joint tape 952 attached to it. The tape is fed through the automatic taper's head 802. At the head 802, the joint tape 952 is coated with joint compound 953 prior to application. The automatic taper 801 replaces the need for drywall tools such as hawks, trowels, knives, etc. An automatic taper 801 shown in FIG. 8 may be repaired if joint compound is jammed in the taper 801 or if a wheel breaks. Repairing broken drywall equipment in the motor vehicle 303 may save time, especially if the vehicle is onsite. Cleaning of drywall equipment is also very important. If joint compound 953 hardens, it may ruin drywall equipment. The automatic taper 801, for example, contains joint compound 953 and distributes it through the head 802. Because of this, the head 802 may become covered in joint compound 953, and, if allowed to dry, may damage the taper 801. Additionally, if joint compound 953 is allowed to dry inside the automatic taper 801, the distribution of joint compound 953 may be affected.

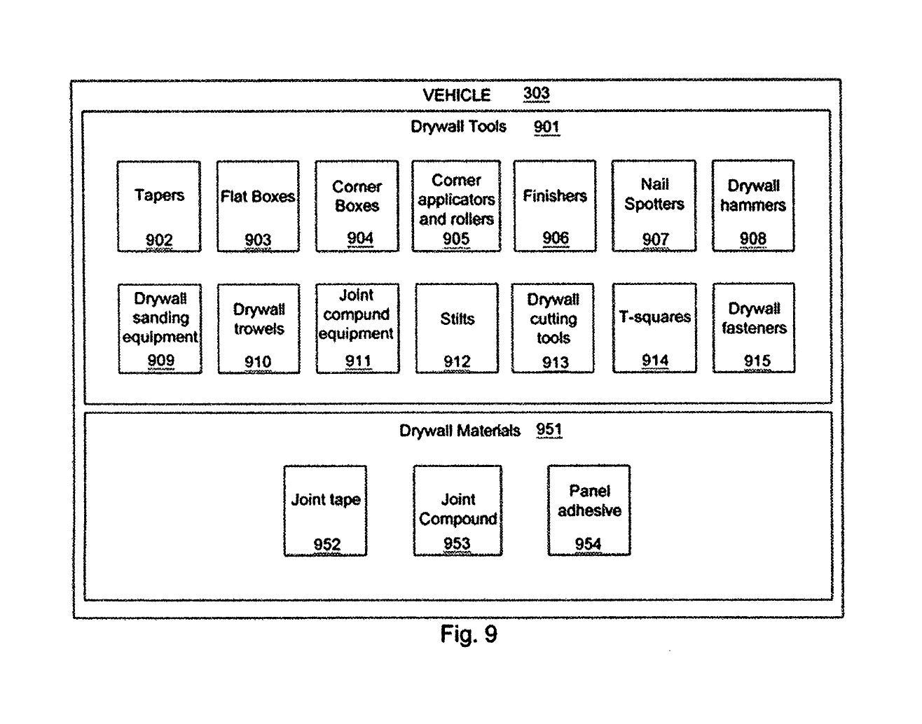

FIG. 9 is a schematic of an embodiment of drywall equipment that may be stocked in the motor vehicle 303. The drywall equipment may comprise drywall tools 901 and drywall materials 951. The drywall tools may comprise tapers 902, flat boxes 903, corner boxes 904, corner applicators and rollers 905, finishers 906, nail spotters 907, drywall hammers 908, dry wall sanding equipment 909, drywall trowels 910, drywall joint compound equipment 911, stilts 912, drywall cutting tools 913, T-squares 914, and drywall fasteners 915. The drywall materials 951 may comprise joint tape 952, joint compound 953, and panel adhesive 954. The tapers 902 may comprise automatic tapers 801 and manual tapers. The finishers 906 may comprise corner finishers and flat finishers. The drywall sanding equipment 909 may comprise sponges, sandpaper, and mechanical sanders (such as a belt sander). The drywall joint compound equipment 911 may comprise hawks, loading pumps, mud mashers, mud pans, mud buckets, and mixers.

Whereas the present invention has been described in particular relation to the drawings attached hereto, it should be understood that other and further modifications apart from those shown or suggested herein, may be made within the scope and spirit of the present invention.

What is claimed is:

1. A method for conducting a drywall equipment business, the method comprising the steps of:
providing a motor vehicle suitable for stocking drywall equipment;
staffing the motor vehicle with a first party;
the first party providing drywall equipment to a second party from the motor vehicle; and
the first party charging the second party for providing at least some of the drywall equipment.

2. The method of claim 1, wherein the step of providing the drywall equipment comprises a rental.

3. The method of claim 1, wherein the step of providing the drywall equipment comprises a lease.

4. The method of claim 1, wherein the step of providing the drywall equipment comprises a sale.

5. The method of claim 1, wherein the second party is an end user or an agent of the end user.

6. The method of claim 5, wherein the end user comprises a contractual employee, part-time employee, full-time employee, seasonal employee, volunteer, or do-it-yourselfer.

7. The method of claim 1, wherein the motor vehicle is selected from the group consisting of automobiles, automobiles with trailers, trucks, trucks with semi trailers, airplanes, trains, and boats.

8. The method of claim 1, wherein the motor vehicle comprises a system related to payment which comprises creating an invoice, initiating payment, processing payment, completing payment, confirming payment, creating a receipt, and combinations thereof.

9. The method of claim 8, wherein the system is connected to a remote location via a wireless connection.

10. The method of claim 1, wherein the step of charging the second party is performed proximate the motor vehicle.

11. The method of claim 1, wherein the motor vehicle comprises a system to manage inventory.

12. The method of claim 11, wherein the system to manage inventory is connected to a remote location via a wireless connection.

13. The method of claim 1, wherein the motor vehicle comprises a plurality of racks and shelves for storage of drywall equipment.

14. The method of claim 1, wherein the drywall equipment comprises drywall tools selected from the group consisting of tapers, flat boxes, corner boxes, corner applicators and rollers, finishers, nail spotters, drywall hammers, drywall sanding equipment, drywall trowels, drywall joint compound equipment, stilts, T squares, drywall fasteners, and combinations thereof.

15. The method of claim 1, wherein the drywall equipment comprises drywall materials selected from the group consisting of joint tape, joint compound, panel adhesive, and combinations thereof.

16. The method of claim 1, further comprising the step of providing services pertaining to the drywall equipment comprising repairing, cleaning, replacing, replenishing, upgrading, or combinations thereof.

17. The method of claim 16 wherein the motor vehicle comprises an area to perform the services pertaining to the drywall equipment.

18. The method of claim 17, wherein the area to perform services pertaining to the drywall equipment comprises a recirculating washer.

19. The method of claim 18, wherein the recirculating washer comprises an enclosed washing area.

20. The method of claim 18, wherein the recirculating washer is connected to an electrical system located on the motor vehicle.
